(19) United States
(12) Patent Application Publication
(10) Pub. No.: US 2016/0191797 A1
(43) Pub. Date: Jun. 30, 2016

(54) Image Processing Device and Image Playback Device Which Control Display Of Wide-Range Image

(71) Applicant: CASIO COMPUTER CO., LTD., Shibuya-ku (JP)

(72) Inventor: Takeshi OKADA, Itabashi-ku (JP)

(73) Assignee: CASIO COMPUTER CO., LTD., Tokyo (JP)

(21) Appl. No.: 14/949,455

(22) Filed: Nov. 23, 2015

(30) Foreign Application Priority Data
Dec. 26, 2014 (JP) 2014-265582

(51) Int. Cl. H04N 5/232; H04N 5/262

(52) U.S. Cl. CPC H04N 5/23238; H04N 5/23293; H04N 5/2628

(57) ABSTRACT

When a wide-range image whose specific imaging area serves as a display target in playback of the wide-range image is captured, a specific object representing a light spot present in the wide-range image is identified; positional information indicating the position of the identified object in the wide-range image is acquired; and the wide-range image and the acquired positional information are outputted to a storage section in association with the wide-range image. In the playback of this wide-range image, a display target area is set based on the positional information associated with the wide-range image. As a result of this configuration, an image of a portion of a wide-range image showing a specific object is always displayed regardless of the orientation of the camera body in the image capturing.

### CROSS-REFERENCE TO RELATED APPLICATION

This application is based upon and claims the benefit of priority from the prior Japanese Patent Application No. 2014-265582, filed Dec. 26, 2014, the entire contents of which are incorporated herein by reference.

### BACKGROUND OF THE INVENTION

1. Field of the Invention

The present invention relates to an image processing technology and a playback technology for wide-range images such as omnidirectional (whole-sky) images.

2. Description of the Related Art

Conventionally, an omnidirectional camera is known which combines images captured respectively using a plurality of super-wide-angle lenses such as fisheye lenses such that they are connected to one another, and thereby generates and records an omnidirectional (whole-sky) image corresponding to an imaging range of 360 degrees (for example, refer to Japanese Patent Application Laid-open (Kokai) Publication No. 2014-078926).

When this omnidirectional image captured by the omnidirectional camera is replayed, a portion of the image in a predetermined area is displayed on a display device as a display target. Then, by this area (hereinafter referred to as “display target area”) being switched as required, the whole omnidirectional image can be checked.

### SUMMARY OF THE INVENTION

In accordance with one aspect of the present invention, there is provided an image processing device comprising: an identification section which identifies a specific object present in a wide-range image; an acquisition section which acquire positional information indicating a position of the object in the wide-range image identified by the identification section; and an output section which associates the positional information acquired by the acquisition section with the wide-range image, and outputs the wide-range image and the positional information.

In accordance with another aspect of the present invention, there is provided an image playback device comprising: an image display section; an acquisition section which acquires a wide-range image whose specific imaging area serves as a display target when the wide-range image is replayed, and positional information associated with the wide-range image and indicating a position of a specific object in the wide-range image; a setting section which sets a display target area in the wide-range image acquired by the acquisition section, based on the positional information acquired by the acquisition section; and a display control section which controls an image of the display target area set in the wide-range image by the setting section to be displayed on the image display section.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing an imaging system according to an embodiment of the present invention; FIG. 2A is a schematic view showing the physical structure of an imaging device;

FIG. 2B is a schematic view showing the physical structure of another imaging device;

FIG. 3 is a flowchart of moving image capture processing; FIG. 4 is a flowchart of moving image playback processing;

FIG. 5A is a diagram showing a display example of an omnidirectional (whole-sky) image;

FIG. 5B is a diagram showing another display example of the omnidirectional (whole-sky) image;

FIG. 5C is a diagram showing still another display example of the omnidirectional (whole-sky) image;

FIG. 6A is a diagram showing an example of the usage of the imaging system;

FIG. 6B is a diagram showing another example of the usage of the imaging system;

FIG. 6C is a diagram showing still another example of the usage of the imaging system;

FIG. 7A is a diagram showing yet another example of the usage of the imaging system;

FIG. 7B is a diagram showing display examples of omnidirectional (whole-sky) images; and

FIG. 8 is a diagram showing an example of the usage of an imaging system using a plurality of visible light devices.

### DETAILED DESCRIPTION OF THE PREFERRED EMBODIMENTS

Hereafter, an embodiment of the present invention is described. Note that, in the following descriptions regarding the embodiment, omnidirectional images and whole-sky images are collectively referred to as omnidirectional images.

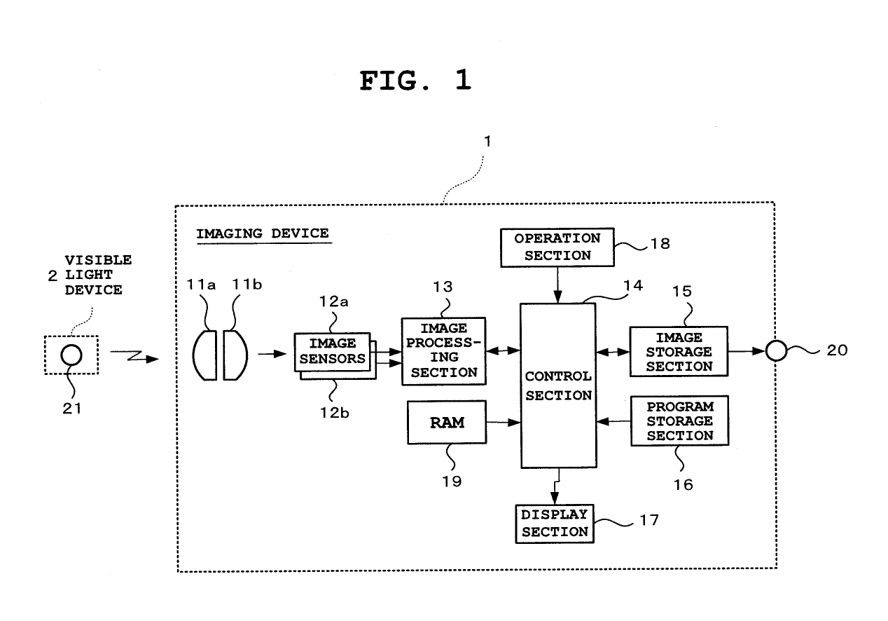

FIG. 1 is a block diagram of an imaging system shown as an embodiment of the present invention, which is constituted by an imaging device 1 and a visible light device 2 having functions necessary to serve as an imaging device and an image playback device according to the present invention.

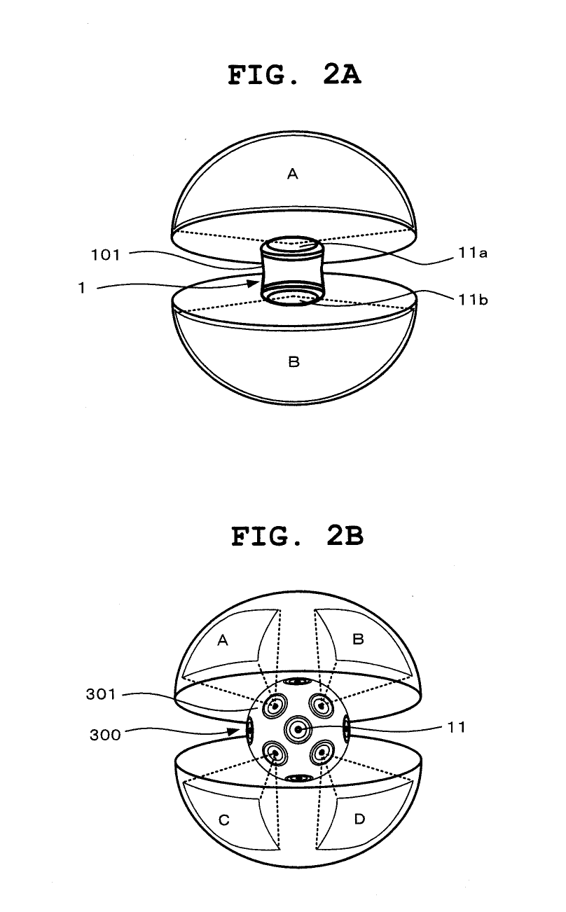

The imaging device 1 is a camera capable of capturing omnidirectional images showing the entire imaging range of 360 degrees. Specifically, the imaging device 1 has a structure where a pair of wide-angle lenses (so-called fisheye lenses) 11a and 11b having a viewing angle of more than 180 degrees has been arranged opposite to each other with their optic axes coinciding with the device main body 101, as shown in FIG. 2A.

This imaging device 1 includes image sensors 12a and 12b corresponding to the pair of wide-angle lenses 11a and 11b, an image processing section 13, a control section 14, an image storage section 15, a program storage section 16, a display section 17, an operation section 18, a RAM (Random Access Memory) 19, and an output section 20, as shown in FIG. 1.

The image sensors 12a and 12b are solid-state image sensing devices, such as CCDs (Charge Coupled Devices) and CMOSs (Complementary Metal Oxide Semiconductors). By their driving circuits not shown being driven, the outer peripheries of optical images formed respectively by the wide-angle lenses 11a and 11b overlap with each other, viewing angle ranges A and B in directions different from each other by 180 degrees are respectively imaged, and the optical images are outputted to the image processing section 13 as imaging signals.

The image processing section 13 includes an AFE (Analog Front End) that amplifies an imaging signal supplied from the image sensors 12a and 12b and converts it to a digital signal, and an image processing circuit that generates image data (YUV data) constituted by a luminosity (Y) component and a color difference (UV) component from the digital signal after the conversion, and performs various types of image processing based on the generated image data.

The above-described image processing includes processing where predetermined image data is created which represents a connected image acquired by seamlessly connecting overlapping portions of two images individually captured by the image sensors 12a and 12b and showing viewing angle ranges A and B (refer to FIG. 2A) in directions different from each other by 180 degrees, that is, an omnidirectional image showing photographic subjects in top, bottom, left, and right areas in 360-degree directions.

This omnidirectional image is an image arranged in a three-dimensional space defined by spherical coordinates representing a virtual sphere centering on the position of the imaging device 1, and the image data thereof is image data where the center of one of the above-described two images is a reference position on the spherical coordinates. Note that, as is well known, each position on the spherical coordinates is defined by the radius of the sphere, that is, a radius vector r between the imaging device 1 and the surface of the sphere, and deflection angles θ and φ (the radius vector r has a fixed value).

In still image capturing, image data generated by the image processing section 13 is compressed by the control section 14 as still image data in, for example, a JPEG (Joint Photographic Experts Group) format, and stored in the image storage section 15 as a still image file to which various attribution information has been added. In moving image capturing, pieces of image data are sequentially compressed by the control section 14 as moving image data in, for example, a MPEG (Motion Picture Experts Group) format, and stored in the image storage section 15 as a moving image file to which various attribution information has been added.

The image storage section 15 is constituted by, for example, a flash memory embedded in the imaging device 1, and various memory cards detachably attached to the imaging device 1. Still image data or moving image data stored in the image storage section 15 as a still image file or a moving image file are read out and decoded by the control section 14 as necessary, and then supplied to the display section 17.

The program storage section 16 is constituted by, for example, a non-volatile memory such as a flash memory where stored data can be rewritable any time, or a ROM (Read Only Memory). In the program storage section 16, the above-described control program and a predetermined program for causing the control section 14 to perform processing described later are stored in advance.

The control section 14 mainly includes a CPU (Central Processing Unit), its peripheral circuits, and the like, and controls each of the above-described sections in accordance with the control program stored in the program store section 16. Also, this control section 14 uses the RAM 19 as a working memory and performs various types of processing including the coding and decoding of the above-described image data.

The display section 17 is constituted by, for example, a liquid-crystal-display panel and its drive circuit, and displays captured image (still image or moving image) based on image data supplied from the control section 14.

The operation section 18 is constituted by, for example, a plurality of operation switches which are used by the user to operate the imaging devices 1 so as to start or end still image capturing or moving image capturing, or to input various setting data for specifying details of an operation by the imaging device 1, and supplies an input signal according to a user operation to the control section 14. Note that the operation status of each operation switch is continuously monitored by the control section 14.

The output section 20 is constituted by various communication interfaces for making data communication such as cable communication and wireless communication (short distance communication and the like) with external devices, and outputs still image data or moving image data stored in the image storage section 15 as a still image file or a moving image file to an arbitrary external device.

The visible light device 2 is constituted by a light emitting element 21 such as a LED (Light Emitting Diode) that emits visible light having a specific light emission pattern, a power source not shown, and a lighting switch not shown, and informs the imaging device 1 of the position of a main photographic subject in a viewing field by emitting visible light.

In the imaging system of the present embodiment, when the user is to perform image capturing by using the imaging device 1, the visible light device 2 is arranged on an arbitrary object, person, or place serving as a main photographic subject, the light emitting element 21 enters a lit state by the lighting switch, and the photographic subject is captured, whereby the present invention is actualized.

That is, the imaging device 1 has a moving image capturing mode and a still image capturing mode as image capturing modes, and has, as a subsidiary mode of each image capturing mode, a predetermined image capturing mode in which a light spot having a specific light emission pattern by visible light emitted from the visible light device 2 is detected as the position of a main photographic subject during image capturing. In this predetermined image capturing mode, the imaging device 1 is operated as follows by the user.

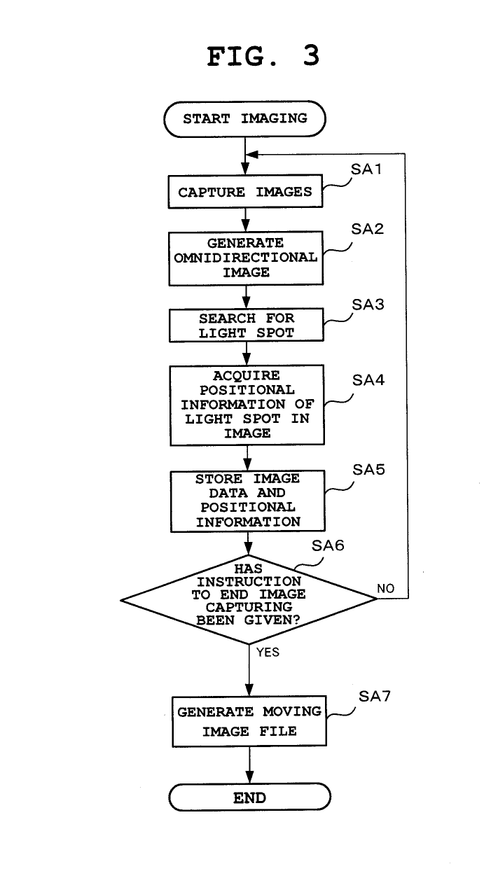

FIG. 3 is a flowchart showing details of moving image capture processing that is performed by the control section 14 in the predetermined image capturing mode.

In the moving image capturing mode, the control section 14 starts driving each image sensor 12a and 12b so as to perform image capturing at a predetermined frame rate (for example, 60 fps), in response to a user operation for instructing to start moving image capturing. Then, the control section 14 captures images at imaging timing according to the frame rate (Step SA1). That is, the control section 14 captures a photographic subject by the image sensors 12a and 12b.

Next, the control section 14 controls the image processing section 13 to generate an omnidirectional image (Step SA2).

Subsequently, the control section 14 searches the generated omnidirectional image for a light spot having a specific light emission pattern by visible light emitted by the visible light device 2, based on the luminosity information and the color information of each pixel in the omnidirectional image, and takes the light spot as a specific target (Step SA3).

Next, the control section 14 acquires positional information indicating the position of the light spot in the omnidirectional image, that is, information regarding its position on spherical coordinates, (r, θ, and φ) (Step SA4).

Next, the control section 14 codes the data of the omnidirectional image generated at Step SA2, and stores it in the image storage section 15 as image data that constitutes a frame of a moving image, in association with the above-described positional information (Step SA5). Note that, as a specific method for storing the positional information, any method can be adopted as long as the positional information can be associated with the image data acquired at the current frame timing. For example, the positional information may be stored in the image storage section 15 as additional information for the moving image data, or stored independently from the moving image data for each frame.

Hereafter, the control section 14 returns to Step SA1 (NO at Step SA6) and, until an operation for instructing to end the image capturing is performed by the user, repeats the above-described processing.

Then, when an operation for instructing to end the image capturing is performed by the user (YES at Step SA6), the control section 14 ends the moving image capture processing at this point, and generates a moving image file in the image storage section 15 (Step SA7). Specifically, the control section 14 generates a moving image file by adding the positional information and various attribute information to the image data of each frame stored in the image storage section 15 by the processing of Step SA4. In this manner, the moving image capture processing by the control section 14 is ended.

FIG. 4 is a flowchart showing details of playback processing that is performed by the control section 14 when a playback mode is set by the user and a moving image captured by the above-described moving image capture processing, that is, a moving image to which positional information has been added for each frame is selected as a captured image to be replayed.

In the playback processing, the control section 14 reads out from the image storage section 15 the image data of each frame constituting moving image data, and positional information associated therewith (Step SB1). Here, the control section 14 decodes the read image data, and develops it in the RAM 19 as image data that can be displayed.

Next, the control section 14 identifies, for this image data, a display target area centering on the position of a light spot indicated by the positional information (Step SB2). Here, the control section 14 identifies this display target area based on the position of the light spot on the above-described spherical coordinates which is an area on the omnidirectional image, and the display magnification. The display magnification herein corresponds to a viewing angle when the light spot positioned on the surface of the above-described sphere is imaged from the center of the sphere. Note that the display magnification when the processing is started has an initial value determined in advance. In the present embodiment, it is display magnification where the above-described viewing angle is 180 degrees, or in other words, display magnification where the half of the area of an omnidirectional image is a display target area.

Then, the control section 14 cuts out the image data of the display target area from the image data developed in the RAM 19 (Step SB3), and displays the present frame image on the screen of the display section 17 by providing the cut-out image data to the display section 17 (Step SB4).

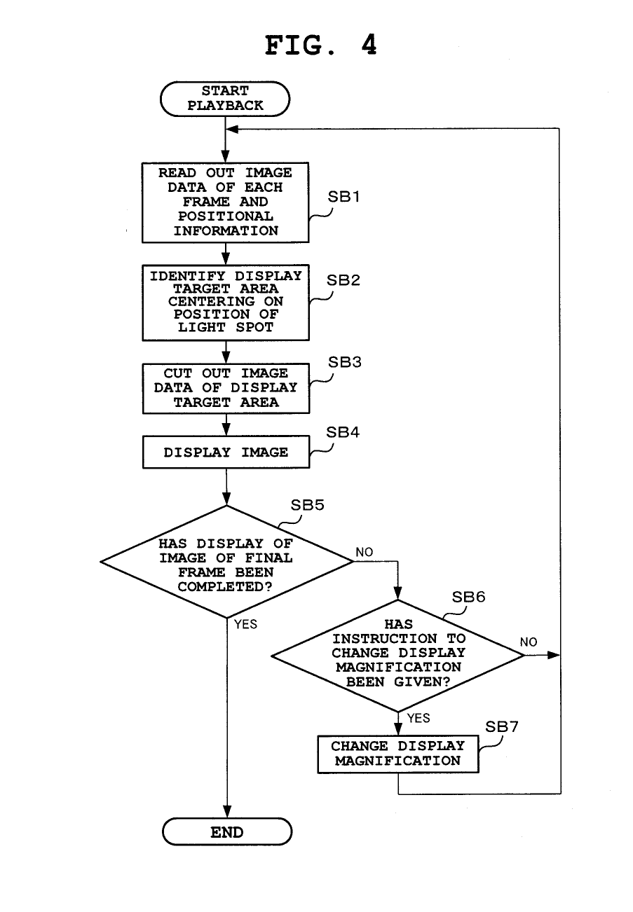

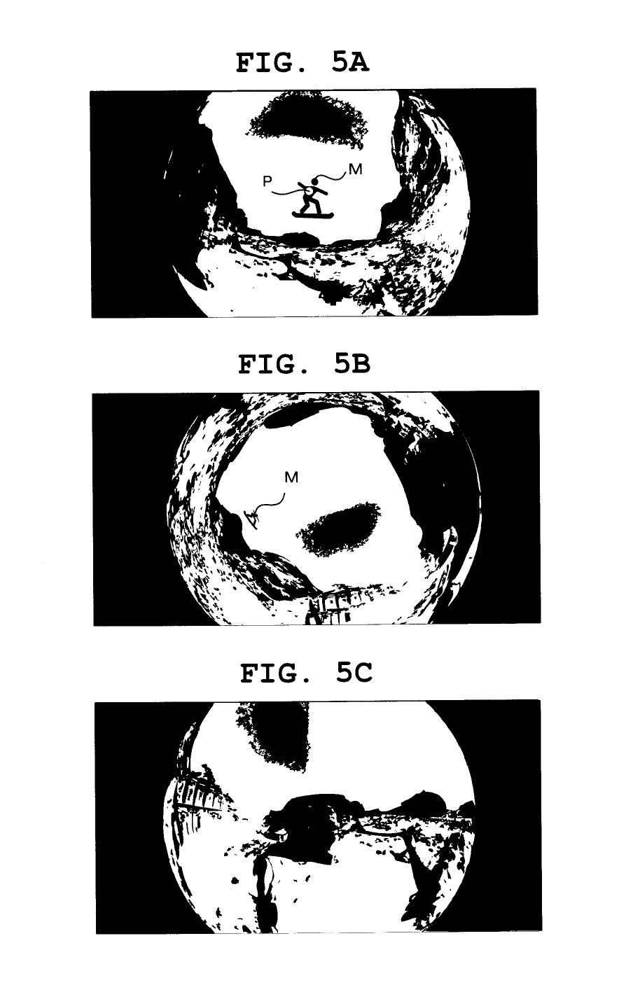

FIG. 5A is a diagram showing an example of the frame image displayed by the processing of Step SB4, in which the display magnification has an initial value. In the example in FIG. 5A, a replayed moving image shows a person M riding a snowboard (or skateboard) and jumping with the visible light device 2 being attached. The point indicated by P in the drawing is a light spot, that is, the light source of the visible light device 2.

Then, when the display of the image of the final frame has not been completed (NO at Step SB5) and no instruction for changing the display magnification has been given by the user (NO at Step SB6), the control section 14 repeatedly returns to the processing of Step SB1, reads out the image data of the next frame and positional information associated with the image data, and performs the processing of Step SB3 to Step SB4.

As a result, even if the relative positional relationship between the imaging device 1 and the person M who is a main photographic subject has been changed during the image capturing of this replayed moving image, images where the person M is positioned at the center are always displayed as the following frame images. That is, an image such as that shown in FIG. 5B where the person M is positioned at a peripheral portion of an image or an image such as that shown in FIG. 5C where the person M is not present in an image are not displayed as frame images.

At some point during the playback, when an instruction to change the display magnification is given by the user (YES at Step SB6), the control section 14 changes the display magnification (Step SB7), returns to the processing of Step SB1, and repeats the above-described operations. As a result of this configuration, even during the moving image playback, the user can view, for example, a moving image where the person M is displayed in a large size on the screen, by changing the display magnification as necessary.

Then, when the display of the image of the final frame is completed (YES at Step SB5), the control section 14 ends the playback processing.

As described above, in the present embodiment, a main photographic subject is imaged with the visible light device 2 being attached thereto. As a result, even when the positional relationship between the main photographic subject and the imaging device 1 is relatively changed, or in other words, even when one or both of the positions of the main photographic subject and the imaging device 1 is/are changed during moving image capturing, a moving image where the main photographic subject is positioned at the center of the screen is always displayed.

Accordingly, in a moving image displayed in the present embodiment, a specific target intended to serve as a main photographic subject at the time of image capturing is not significantly changed in the moving image, or disappeared from the moving image. That is, omnidirectional images captured by moving image capturing are always favorably displayed.

In addition, in the playback of omnidirectional images captured by moving image capturing, display target areas in the omnidirectional images which are cut out as frame images and displayed have ranges according to display magnification. Accordingly, the size of a displayed main photographic subject can be adjusted.

Also, the imaging device 1 searches the omnidirectional image of each frame during moving image capturing for a light spot having a specific light emission pattern by visible light emitted from the visible light device 2, with the light spot as a specific target, and then stores positional information indicating the position of the specific target in association with the omnidirectional image of each frame. That is, the imaging device 1 detects the position of the light spot as the position of the main photographic subject in the omnidirectional image of each frame. As a result, the user can unfailingly know the position of the main photographic subject in the omnidirectional image of each frame.

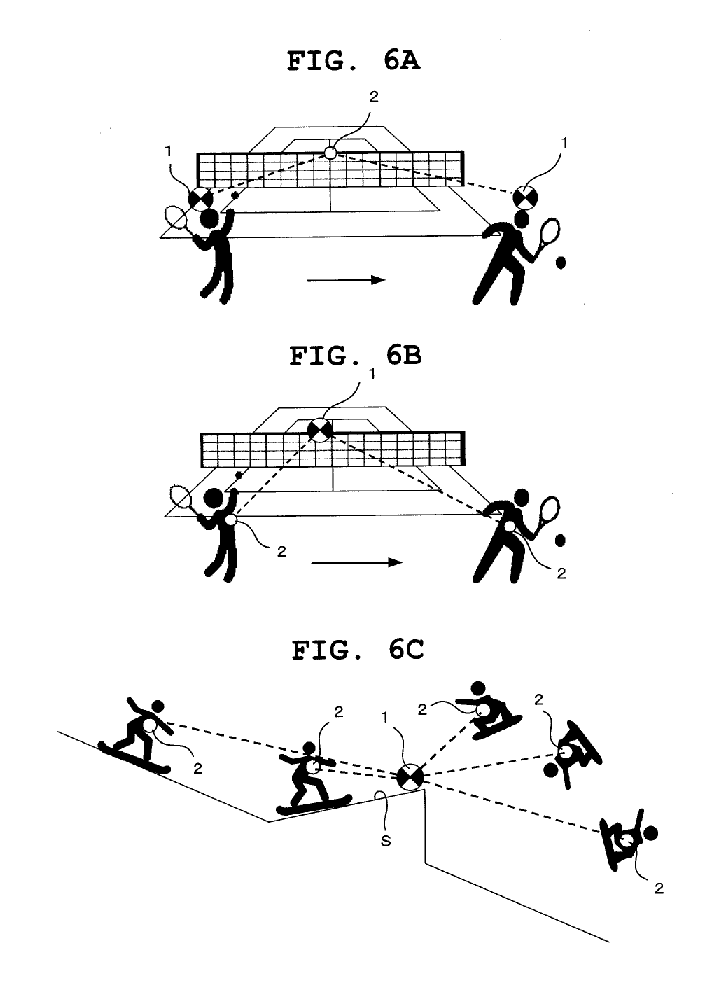

Here, the usage of the above-described imaging system in the present embodiment is described. As a usage example thereof, there is a case where the visible light device 2 is arranged on a middle area of a tennis net in a tennis practice or match, the imaging device 1 is worn on a tennis player, and image capturing is performed, as shown in FIG. 6A. In this case, the tennis player moves during the image capturing. However, in a moving image replayed after the image capturing, the center of the tennis net is always positioned at the center of the screen. Therefore, only by being replayed, the moving image can be displayed such that the movement of an opponent player on the other side of the tennis net is checkable while the view point is being moved along with the movement of the tennis player.

Also, in a tennis practice or match, there is an opposite case where the imaging device 1 is arranged on a middle area of a tennis net, the visible light device 2 is worn on a tennis player, and image capturing is performed, as shown in FIG. 6B. In this case, although the tennis player moves during the image capturing, the tennis player in a moving image replayed after the image capturing is always positioned at the center of the screen. Therefore, only by being replayed, the moving image can be displayed such that the view point is changed following the tennis player.

Also, as another usage example, there is a case where the imaging device 1 is set on snow-covered ground S, the visible light device 2 is worn on a snowboarder, and the sliding state of the snowboarder is imaged, as shown in FIG. 6C. In this case, even when the movement amount and the movement range of the snowboarder are large, the snowboarder in a moving image replayed after the image capturing is always positioned at the center of the screen. Therefore, only by being replayed, the moving image can be displayed such that the view point is changed following the snowboarder.

Hereafter, a modification example of the present embodiment is described. In the imaging system of the above-described embodiment, the imaging device 1 includes the pair of wide-angle lenses 11a and 11b, and generates an omnidirectional image from two images captured by the image sensors 12a and 12b corresponding to the wide-angle lenses 11a and 11b.

However, in this imaging system, a ball-type imaging device 300 may be used which has a plurality of lenses 11 provided over the entire surface of its ball-type device body 301 and generates an omnidirectional image from a plurality of images, that is, images having a plurality of different viewing angle ranges A, B, C, D, . . . captured by a plurality of image sensors corresponding to the respective lenses 11.

By image capturing being performed with a main photographic subject wearing the visible light device 2 and by the ball-type imaging device 300 performing processing equivalent to that of the above-described imaging device 1 in moving image playback, a moving image where the main photographic subject is always positioned at the center of the screen can be displayed even if the positional relationship between the ball-type imaging device 300 and the main photographic subject has relatively changed during the moving image capturing.

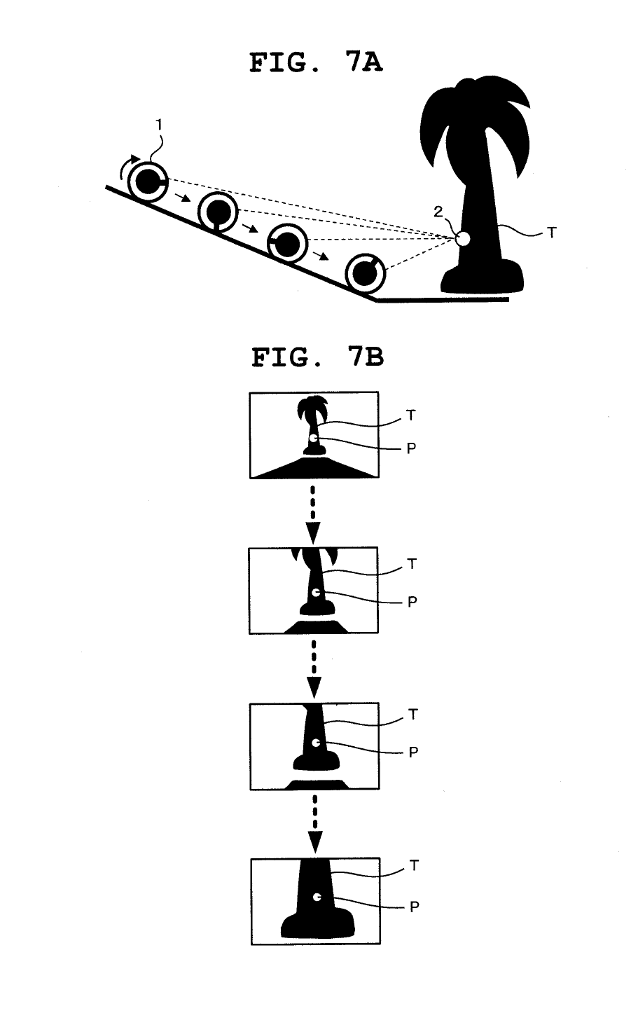

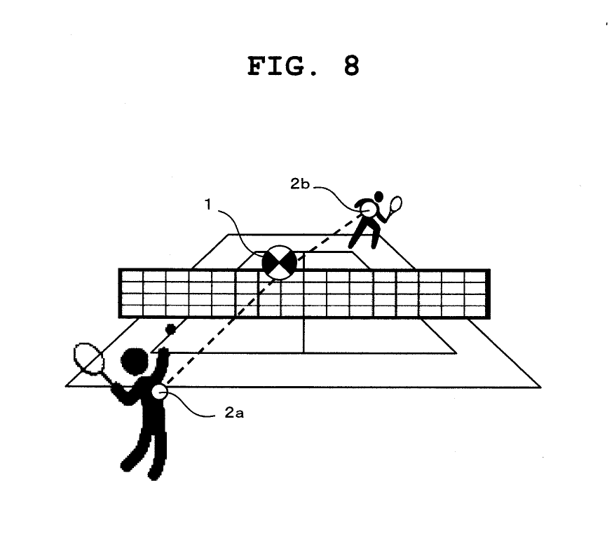

For example, when the visible light device 2 is set on an arbitrary fixed object T (tree in the drawing) and a moving image captured while the ball-type imaging device 300 is rolling toward the fixed object T from a distant point is replayed, frame images where a predetermined portion of the fixed object T having the light spot P is always positioned at the center are displayed, as shown in FIG. 7B. Note that FIG. 7B is an example where high display magnification has been set for moving image playback and display target areas (the above-described viewing angle) that are displayed as frame images cut out from omnidirectional images are relatively narrow.

In the present embodiment, the imaging device 1 has the function for serving as the image playback device of the present invention. However, the image playback device of the present invention may be any device as long as it has a function for replaying (displaying) a moving image whose frames are omnidirectional images. For example, the present invention can be actualized by an arbitrary image playback device such as a a personal computer. In this case as well, the arbitrary image playback device performs the playback processing shown in FIG. 4 when replaying a moving image captured by the imaging device 1 by using the above-described predetermined moving image capturing mode, so that omnidirectional images captured as the moving image are always favorably displayed, as in the case of the present embodiment.

Also, in the case where the present invention is actualized by the arbitrary image playback device, a moving image to be replayed is not limited to a moving image captured by the imaging device 1 and stored as a moving image file, and may be a moving image based on the image (omnidirectional image) data of each frame provided from the imaging device 1 or the like in real time during moving image capturing and having positional information attached thereto.

That is, in the case where the present invention is actualized by the arbitrary image playback device, a configuration is adopted in which the imaging device 1 provides, during moving image capturing using a position detection function, the image (omnidirectional image) data of each frame having positional information attached thereto to the arbitrary image playback device via the output section 20 in real time by wired or wireless communication. As a result, omnidirectional images captured as a moving image are always favorably displayed by the arbitrary image playback device that is an external device.

Moreover, in the present embodiment, in the image capture processing in the predetermined moving image capturing mode, the imaging device 1 detects only a light spot having a specific light emission pattern from the omnidirectional image of each frame. However, the configuration described below may be adopted.

In this configuration, in the image capture processing in the predetermined moving image capturing mode, the imaging device 1 detects a plurality of light spots having different light emission patterns from the omnidirectional image of each frame individually, and stores the position of each light spot in the omnidirectional image in association with the image data of the omnidirectional image.

Then, before the above-described playback processing (or during the playback processing), the imaging device 1 prompts the user to specify the light emission pattern of a light spot in the omnidirectional image of each frame which is used as a main photographic subject. Subsequently, in the playback processing, the imaging device 1 determines a display target area which is cut out from the omnidirectional image and displayed as a frame image, based on the position of the light spot having the specific light emission pattern specified by the user. In this configuration, plural types of moving images whose photographic subjects are different from each other and always positioned at the center of the screen can be displayed.

As a usage example of this configuration, there is a case where the imaging device 1 is arranged on a middle area of a tennis net in a tennis practice or match, a first visible light device 2a that emits visible light having a first light emission pattern is worn on one of two opposing tennis players, a second visible light device 2b that emits visible light having a second light emission pattern different from the first light emission pattern is worn on the other player, and image capturing is performed. In this case, two types of moving images where the two tennis players are each a main photographic subject can be displayed from a single omnidirectional image acquired by the moving image capturing.

Furthermore, in the present embodiment, the imaging device 1 searches the omnidirectional image of each frame during moving image capturing for the above-described light spot, takes the light spot as a specific target, and stores positional information indicating the position of the target in association with the omnidirectional image of each frame.

However, in the implementation of the present invention, this specific target, for which the omnidirectional image of each frame during moving image capturing is searched, is not necessarily a light spot, and may be any object as long as it can be identified in the omnidirectional image of each frame. For example, an object (emblem or the like) having a specific shape may be used, or an object recognition technique for recognizing a specific person may be used.

However, in a configuration such as that of the present embodiment where the specific target is a light spot, the specific target can be quickly and reliably detected from the omnidirectional image of each frame without complicated image recognition processing. Accordingly, cases can be supported in which the positional relationship between a main photographic subject and the imaging device 1 quickly changes during moving image capturing.

Still further, in the present embodiment, omnidirectional images to be displayed are moving images. However, they may be still images. Even in this case where omnidirectional images are still images, the still images are displayed such that a main photographic subject is always positioned at the center of the screen as a captured image regardless of the positional relationship between the imaging device 1 and the main photographic subject during image capturing. As a result of this configuration, the user can check a main photographic subject in an omnidirectional image without moving a display target area in the omnidirectional image by him or herself. That is, omnidirectional images that are still images are always favorably displayed.

Note that, even in the case where omnidirectional images to be displayed are still images, plural types of still images whose main photographic subjects are different from each other and always positioned at the center of the screen can be displayed from a single captured omnidirectional image by visible light devices 2, each of which emits visible light having a light emission pattern different from that of the other one, being attached on a plurality of objects that serve as main photographic subjects, as in the case where omnidirectional images to be displayed are moving images. In this case, the main photographic subjects can be identified not only by the difference between the light emission patterns of the visible light (light spots) but also by the difference between the visible light colors.

Also, the present invention can be used for wide-range images other than omnidirectional images as long as they are images that are replayed on the screen by partial display. For example, the present invention is effective when hemispherical images, panoramic images showing photographic subjects within a predetermined angle range, or the like are displayed after being captured.

Also, in the above-described embodiment, the positional information of a specific object in an image is outputted as additional data for the image data. However, a configuration may be adopted in which a predetermined area is cut out from an image based on the positional information of a specific object.

While the present invention has been described with reference to the preferred embodiments, it is intended that the invention be not limited by any of the details of the description therein but includes all the embodiments which fall within the scope of the appended claims.

What is claimed is:

1. An image processing device comprising:
an identification section which identifies a specific object present in a wide-range image;
an acquisition section which acquire positional information indicating a position of the object in the wide-range image identified by the identification section; and
an output section which associates the positional information acquired by the acquisition section with the wide-range image, and outputs the wide-range image and the positional information.

2. The image processing device according to claim 1, further comprising:
a storage section,
wherein the output section associates the positional information acquired by the acquisition section with the wide-range image, outputs the wide-range image and the positional information to the storage section, and stores the wide-range image and the positional information in the storage section.

3. The image processing device according to claim 1, further comprising:
a storage section; and
a cut-out section which cuts out a predetermined area from the wide-range image based on the positional information of the object in the wide-range image acquired by the acquisition section,
wherein the output section stores the area cut out by the cut-out section in the storage section.

4. The image processing device according to claim 1, further comprising:
an image display section;
a setting section which sets a display target area in the wide-range image based on the positional information associated with the wide-range image; and
a display control section which controls an image of the display target area set in the wide-range image by the setting section to be displayed on the image display section.

5. The image processing device according to claim 4, wherein the setting section sets the display target area within a range according to display magnification.

6. The image processing device according to claim 3, further comprising:
an image display section; and
a display control section which controls the area cut out by the cut-out section to be displayed on the image display section.

7. The image processing device according to claim 1, further comprising:
an imaging section which captures the wide-range image,
wherein the identification section identifies the specific object in the wide-range image captured by the imaging section.

8. The image processing device according to claim 7, wherein the identification section identifies, as the specific object, a light spot (i) generated by predetermined visible light emitted from a light emitting device and (ii) captured by the imaging section.

9. The image processing device according to claim 7, wherein the identification section identifies the specific object in a wide-range image of each frame constituting a moving image captured by the imaging section,
wherein the acquisition section acquires, for each frame, positional information indicating a position of the specific object in the wide-range image of each frame identified by the identification section, and
wherein the output section associates the positional information acquired for each frame by the acquisition section with the wide-range image of each frame, and outputs the positional information.

10. The image processing device according to claim 1, wherein the wide-range image is an omnidirectional image, a hemispherical image, or a panoramic image showing a predetermined angle range.

11. An image playback device comprising:
an image display section;
an acquisition section which acquires a wide-range image whose specific imaging area serves as a display target when the wide-range image is replayed, and positional information associated with the wide-range image and indicating a position of a specific object in the wide-range image;
a setting section which sets a display target area in the wide-range image acquired by the acquisition section, based on the positional information acquired by the acquisition section; and
a display control section which controls an image of the display target area set in the wide-range image by the setting section to be displayed on the image display section.

12. The image playback device according to claim 11, wherein the display control section controls the image of the display target area to be enlarged at a predetermined magnification and displayed on the image display section.

13. The image playback device according to claim 11, wherein the acquisition section acquires wide-range images that serve as a plurality of frames to constitute a moving image, and positional information associated with the wide-range images,
wherein the setting section sets display target areas in the wide-range images acquired by the acquisition section, respectively, based on the positional information acquired by the acquisition section for the respective frames, and
wherein the display control section controls to display, on the image display section, a moving image constituted by images of the display target areas set in the wide-range images by the setting section for the respective frames.

14. The image playback device according to claim 11, wherein the wide-range image is an omnidirectional image, a hemispherical image, or a panoramic image showing a predetermined angle range.

15. An image processing method comprising:
an identification step of identifying a specific object present in a wide-range image;
an acquisition step of acquiring positional information indicating a position of the object in the wide-range image identified in the identification step; and
an output step of associating the positional information acquired in the acquisition step with the wide-range image, and outputting the wide-range image and the positional information.

16. An image playback method comprising:
an acquisition step of acquiring, when a wide-range image whose specific imaging area serves as a display target in playback of the wide-range image is replayed, positional information associated with the wide-range image and indicating a position of a specific object in the wide-range image;
a setting step of setting a display target area in the wide-range image based on the positional information acquired in the acquisition step; and
a display control step of controlling an image of the display target area set in the wide-range image in the setting step to be displayed on an image display section.

17. A non-transitory computer-readable storage medium having stored thereon a program that is executable by a computer in an image processing device to actualize functions comprising:
identification processing for identifying a specific object present in a wide-range image;
acquisition processing for acquiring positional information indicating a position of the object in the wide-range image identified in the identification processing; and
output processing for associating the positional information acquired in the acquisition processing with the wide-range image, and outputting the wide-range image and the positional information.

18. A non-transitory computer-readable storage medium having stored thereon a program that is executable by a computer in an image playback device having an image display section, the program being executable by the computer to actualize functions comprising:
acquisition processing for acquiring a wide-range image whose specific imaging area serves as a display target when the wide-range image is replayed, and positional information associated with the wide-range image and indicating a position of a specific object in the wide-range image;
setting processing for setting a display target area in the wide-range image acquired in the acquisition processing, based on the positional information acquired in the acquisition processing; and
display control processing for controlling an image of the display target area set in the wide-range image by the setting processing to be displayed on the image display section.
